(19) United States
(12) Patent Application Publication
(10) Pub. No.: US 2008/0028339 A1
(43) Pub. Date: Jan. 31, 2008

(54) Control System for a Motor Vehicle

(75) Inventors: Markus Baumann, Stuttgart (DE); Volker Hellwig, Stuttgart (DE); Carla Knoop, Stuttgart (NL); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler, Stuttgart (DE)

(21) Appl. No.: 10/584,457

(22) PCT Filed: Nov. 27, 2004
(86) PCT No.: PCT/EP04/13483

§ 371 Date: Jul. 30, 2007

(30) Foreign Application Priority Data
Dec. 23, 2003 (DE) 103 60 659.9

(51) Int. Cl. G06F 3/048

(52) U.S. Cl. 715/841

(57) ABSTRACT

A control system for a motor vehicle, having a manual actuating means with a plurality of degrees of freedom of adjustment for selecting and/or activating entries in a menu structure with a plurality of menu levels and a screen display having a plurality of display areas for displaying the menu structure, the display areas each including at least one field for displaying one of the entries, wherein, in an active display area in at least one menu level, a plurality of entries are arranged in a display area which is configured as a list. At least one additional field for displaying the position of the currently selected entry in the list can be activated and displayed if a number of entries exceeds a maximum number of entries which can be displayed in the list.

### BACKGROUND AND SUMMARY OF THE INVENTION

The invention relates to a control system for a motor vehicle.

In modern vehicles, multimedia control systems are being increasingly used. An example of this is the command system in the Mercedes Benz S-class.

German Patent Document DE 197 52 056 A1 describes a control system of the generic type, in particular for a motor vehicle. In this control system, two display areas are displayed on a screen display in a menu structure with a plurality of menu levels. A first display area is arranged as a frame around the second display area. In a first menu level, eight fields with entries which correspond to applications which can be carried out and which are arranged vertically and horizontally are displayed in the first display area. An entry is selected by a device pushing or tilting movement of the manual actuating device with a plurality of degrees of freedom of adjustment in the direction of the position of the corresponding entry in the first display area. A selected entry is activated by pressing the manual actuating device. After the activation, a plurality of vertically arranged entries which are assigned to the activated entry in the first menu level are displayed in a second menu level in the second display area. The entries displayed in the second display area are selected by rotational movement of the manual actuating device and activated by pressing the manual actuating device. The activated second display area and the second menu level are exited by the pushing or tilting movement of the manual actuating device in the direction of a position of one of the entries in the first display area. The control system is then located in the first menu level in the first display area again.

The object of the invention is to specify an improved control system for a motor vehicle which permits intuitive control and which reduces the scope of distracting information.

The invention is based on the concept that when a plurality of entries are arranged in a display area which is configured as a list, at least one additional field for displaying the position of the currently selected entry in the list can be activated and displayed in at least one menu level within the active display area if the number of entries exceeds a maximum number of entries which can be displayed in the list.

Displaying the current position in a list, for example a submenu list, facilitates the selection of a specific entry if the number of list entries exceeds the maximum number of entries which can be displayed on the screen display.

The additional field may be arranged, for example, above and/or below and/or to the right and/or to the left of the list.

The additional field may be configured, for example, as a scale area with a horizontally arranged scale and/or vertically arranged scale in which the position of the currently selected entry in the list is marked by a particular graphic display.

The particular graphic display may be implemented, for example, by the marking of the current position in the list being implemented with a different shape and/or with a different color and/or with a different size.

Advantageous configurations of the invention are displayed in the drawings and are described below.

### BRIEF DESCRIPTION OF THE DRAWINGS

FIG. 1 is a block circuit diagram of a control system for a motor vehicle;

FIG. 2 is a schematic illustration of a screen display from FIG. 1 in a first menu level; and

FIG. 3 is a schematic illustration of a submenu on the screen display from FIG. 1.

### DETAILED DESCRIPTION OF THE DRAWINGS

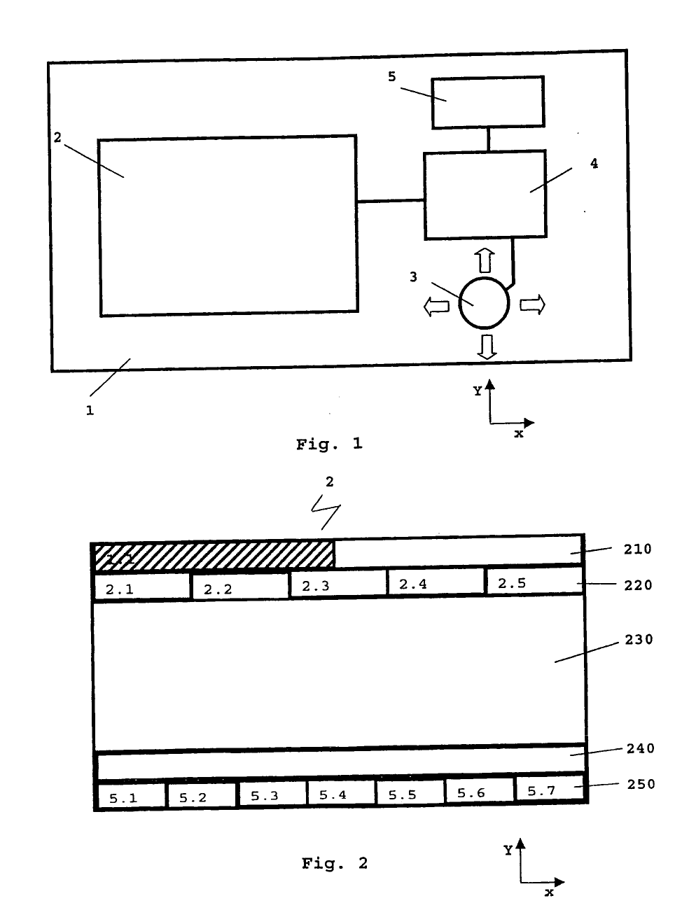

As is apparent from FIG. 1, the control system 1 for a motor vehicle comprises a screen display 2, a manual actuating device 3, a control and evaluation unit 4 and a plurality of vehicle systems such as a navigation system, a heating system and an air conditioning system, a cellular telephone, a video system, an audio system etc. which are illustrated combined as one element 5. The vehicle systems transmit signals to the evaluation and control unit 4 from which the control and evaluation unit 4 determines current system states. All the applications and/or functions and/or subfunctions and/or options and/or status displays in various menu levels of a menu structure are controlled by means of the manual actuating device 3. The latter has seven degrees of freedom of adjustment for selecting and/or activating entries displayed in an active display area. Said actuating device 3 can be pushed in four directions according to the arrow illustration in FIG. 1, i.e. in a positive x direction, a negative x direction, in a positive y direction or in a negative y direction. In addition, it can be rotated in the clockwise direction or in the counter clockwise direction about a z axis (not illustrated) which is perpendicular to the plane of the drawing, and can be pressed in the direction of the negative z direction, i.e. into the plane of the drawing.

Rotating the manual actuating device 3 in the clockwise direction causes a cursor on the screen 2 to move to the right or downward as a function of a horizontal or vertical orientation of the entries displayed on the screen display 2, and turning in the counter clockwise direction causes the cursor to move to the left or upward. Pushing the manual actuating device 3 in FIG. 1 upward, i.e. forward in the direction of the windshield, i.e. in the positive y direction, causes the cursor on the screen display 2 to move upward, and the pushing process in the downward direction in FIG. 1, i.e. toward the rear in the negative y direction, causes the cursor on the screen display 2 to move downward. Pushing to the right, i.e. in the positive x direction, causes the cursor on the screen display 2 to move to the right, and pushing to the left, i.e. in the negative x direction, causes the cursor to move to the left.

The selection and/or activation of an entry displayed on the screen display 2 are carried out by pushing or turning the manual actuating device 3. In a way which is redundant with respect to the vertical pushing along an axis, i.e. with respect to the pushing in the y direction, or with respect to the horizontal pushing along an axis, i.e. with respect to the pushing in the x direction, the manual actuating device 3 can be rotated about the z axis. The pushing direction for selecting an entry corresponds here according to the invention to the orientation of the entries displayed in the active display area. The pushing direction which is respectively orthogonal to the selection pushing direction causes the active display area to be exited. In addition, in order to activate a selected entry it may be necessary to press the manual actuating device 3.

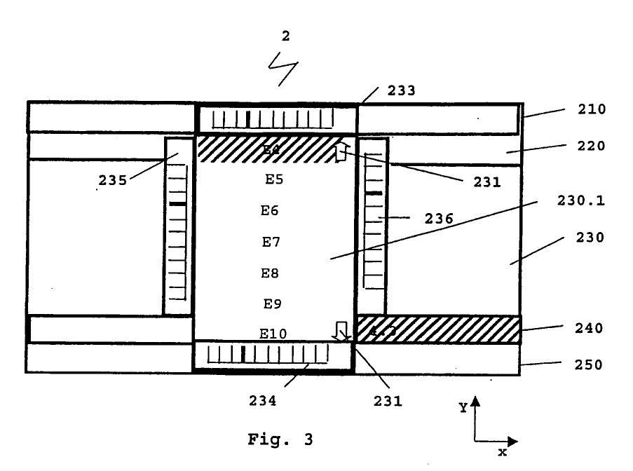

As is clear from FIG. 2, the screen display 2 comprises, in a first menu level, a graphic basic structure of five vertically arranged, horizontal display areas 210 to 250. This graphic basis structure is constant over the multiplicity of various menu levels of the menu structure. The screen display 2 is configured, for example, as an eight inch screen with a ratio of the sides of 15:9. The graphic basic structure of at least a first of the display areas 210 to 250 of the screen display 2 is constant over the multiplicity of various menu levels of the menu structure. In FIG. 2, the display areas 210, 220, 240 and 250 are configured as such first display areas.

The graphic basis structure of at least a second of the display areas 210 to 250 is variable over the multiplicity of various menu levels of the menu structure as a function of an activated application and/or function and/or subfunction and/or option and/or status display. In FIG. 2, the display area 230 is configured as such as second display area. This central display area 230 may be configured graphically in very different ways.

One or more horizontally arranged entries 1.1 to 5.7 may be respectively displayed in the four display areas 210, 220, 240 and 250 which are configured as first display areas. For example, the display areas 210, 220, 240 and 250 in FIG. 2 in the first menu level each comprise a different number of entries. For example, the first display area 210 comprises an entry 1.1, the second display area 220 comprises five entries 2.1 to 2.5, the fourth display area comprises no entry and the fifth display area comprises seven entries 5.1 to 5.7. In FIG. 2, the first display area 210 is activated and the hatched entry 1.1 is selected. The hatched display is intended to indicate that the cursor is positioned on the entry 1.1.

The entries 1.1 to 5.7 of the display areas 210 to 250 displayed on the screen display 2 can be arranged according to the importance of their contents or their frequency of application. When the entries are arranged vertically, the width of the individual fields for displaying the entries 1.1 to 5.7 is dependent, for example, on the length of the longest entry. The field width may be additionally or alternatively dependent on the number of fields in a display area.

FIG. 3 shows a display area 230.1 which has been opened by activating the entry 4.3 from the fourth display area 240 in the third display area 230. The display area 230.1 contains a list which comprises 11 entries in the example in FIG. 3, the entries E4 to E10 of which are illustrated, and which list is configured, for example, as a submenu list. Arrows 231 indicate that there are even more entries in the submenu list which can be selected. Additional fields 233 to 236 which are embodied as scale areas indicate a position of the currently selected entry E4 in the submenu list 230.1 by means of a marking bar which is emphasized in bold within a series of marking bars. The number of marking bars corresponds to the number of selectable entries in the list, i.e. in the example shown in FIG. 3 the scale areas 233 to 236 each comprise 11 marking bars which are assigned to the 11 entries of the submenu list and of which the fourth marking bar is emphasized in bold corresponding to the selected fourth entry E4. In order to represent possible arrangements of the additional field 233 to 236 the first additional fields 233 is arranged, for example, above the submenu list 230.1, the second additional field 234 is arranged below the submenu list 230.1, the third additional field 235 is arranged to the left of the submenu list 230.1, and the fourth additional field 236 is arranged to the right of the submenu list 230.1.

Of course, in alternative configurations of the invention it is also possible for there to be fewer than the four additional fields 233 to 236 shown. For example, when horizontal lists are displayed just one of the two additional fields 233 and 234 or both may be displayed above and/or below the horizontal list, or when there is a vertical list just the additional fields 235 and 236 or just one of said fields is displayed to the left and/or right of the vertical list. The technology described for displaying a position of the selected entry in a list can be applied in any desired menu levels and display areas.

The inventive display of an additional field for displaying the position of the currently selected entry in a list facilitates the selection of a specific entry if the number of list entries exceeds the maximum number of entries which can be displayed on the screen display. As a result, the cognitive load is reduced so that the user can concentrate better on the events on the road.

1-6. (canceled)

7. A control system for a motor vehicle, comprising:
a manual actuating device with a plurality of degrees of freedom of adjustment for at least one of selecting and activating entries in a menu structure with a plurality of menu levels;
a screen display having a plurality of display areas for displaying the menu structure, each of said display areas comprising at least one field for displaying one of the entries wherein, in an active one of said display areas in at least one menu level, a plurality of said entries are arranged in a first display area which is configured as a list and at least one additional field for displaying the position of a currently selected entry in the list is activated and displayed if the number of entries exceeds a maximum number of entries which can be displayed in the list.

8. The control system as claimed in claim 7, wherein the at least one additional field is arranged at least one of above and below the list.

9. The control system as claimed in claim 8, wherein the at least one additional field is configured as a scale area with a horizontally arranged scale in which the position of the currently selected entry in the list is marked by a particular graphic display.

10. The control system as claimed in claim 7, wherein the at least one additional field is arranged at least one of to the left and right of the list.

11. The control system as claimed in claim 10, wherein the at least one additional field is configured as a scale area with a vertically arranged scale in which the position of the currently selected entry in the list is marked by a particular graphic display.

12. The control system as claimed in claim 9, wherein the particular graphic display of the marking is implemented with at least one of a different shape and a different color and a different size.

13. The control system as claimed in claim 8, wherein the at least one additional field is arranged at least one of to the left and right of the list.

14. The control system as claimed in claim 9, wherein the at least one additional field is arranged at least one of to the left and right of the list.

15. The control system as claimed in claim 11, wherein the particular graphic display of the marking is implemented with at least one of a different shape and a different color and a different size.
